(19) United States
(12) Patent Application Publication
(10) Pub. No.: US 2009/0024721 A1
(43) Pub. Date: Jan. 22, 2009

(54) Image Information Sharing System

(75) Inventor: Tetsushi Kumamoto, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/280,765

(22) PCT Filed: Feb. 16, 2007
(86) PCT No.: PCT/JP2007/052837

§ 371 Date: Aug. 26, 2008

(30) Foreign Application Priority Data
Feb. 27, 2006 (JP) 2006-051302

(51) Int. Cl. G06F 15/16; H04L 12/66

(52) U.S. Cl. 709/219; 370/352

(57) ABSTRACT

In an image information sharing system (6) including a portable terminal (1-1) and a portable terminal (1-2), wherein the portable terminal (1-1) and the portable terminal (1-2) are both provided on a network (3), capable of accessing an image database (4) storing a plurality of image files, the portable terminal (1-1) obtains address information indicating an address on the network, of an image file stored in the image database (4), and transmits the obtained address information to the portable terminal (1-2), and the portable terminal (1-2) receives the address information from the portable terminal (1-1), then obtains the image file from the image database (4), based on the received address information, and displays the obtained image file.

### TECHNICAL FIELD

The present invention relates to an image information sharing system, and in particular to a technique for sharing a map image.

### BACKGROUND ART

When meeting someone at a street corner or the like, an image information sharing system may be utilized. The map information display system includes a plurality of computers, such as a portable phone and a personal computer, in which an image file is shared beforehand among the computers so that the same map image is displayed in the respective computers. This system allows a computer user to see the same map image as another computer user in a remote place.

Patent Document 1 discloses a technique concerning this image information sharing system. Specifically, a map image file is shared among computers in either one of two kinds of modes, namely, a file content transmission mode and a file name transmission mode.

In the file content transmission mode, an image file itself is sent from one computer to another. The other computer thus receives the image file to obtain the image file.

In the file name transmission mode, on the other hand, only the file name of an image file is sent from one computer to another. The other computer stores some image files beforehand, and obtains one image file from among those stored therein based on the received file name.

Patent Document 1: Japanese Patent Laid-open Publication No. 2004-221842 (0072 paragraph)

### DISCLOSURE OF THE INVENTION

### Problems to be Solved by the Invention

The file content transmission mode, in which an image file itself is transmitted, has a problem in that as an image file has a relative large size, it takes time to complete the sharing process. Meanwhile, the file name transmission mode, in which file names and image files need to be shared beforehand among computers, has a problem in that this mode is not usable when file names and image files are not shared.

Therefore, one of the objects of the present invention is to provide an image information sharing system capable of sharing a map image without sending an image file itself, even when a file name and an image file are not shared beforehand.

### Means for Solving the Problems

An image information sharing system according to the present invention for solving the above described problem is an image information sharing system including a first computer and a second computer, wherein the first computer and the second computer are both provided on a network, capable of accessing an image database storing a plurality of image files, the first computer includes obtaining means for obtaining address information indicating an address on the network, of an image file stored in the image database, and first computer transmission means for transmitting the address information obtained by the obtaining means to the second computer, and the second computer includes second computer receiving means for receiving the address information from the first computer, image file obtaining means for obtaining the image file from the image database, based on the address information received by the second computer receiving means, and second computer display means for displaying the image file obtained by the image file obtaining means.

With the above, as the address information of an image file is utilized, map image sharing is achieved without sending the image file itself, even when the file name and image file are not shared beforehand between the first computer and the second computer.

In the above described image information sharing system, the second computer may further include second computer transmission means for transmitting to the first computer a display completion notice indicating that displaying by the second computer display means is completed, and the first computer may further include first computer receiving means for receiving the display completion notice from the second computer, and notification means for notifying a user of this computer, when the display completion notice is received by the first computer receiving means, that the display completion notice is received.

With the above, as the user of the first computer can know from the notice by the notification means that an image file is shown in the second computer, it is possible to begin, e.g., explanation of a map with the map image shown in the respective computers.

Further, in the above described image information sharing system, the first computer and the second computer may carry out voice communication using packet communication with each other, and the first computer transmission means may include the address information in a part of a packet related to the voice communication, and transmit the packet.

With the above, it is possible to share a map image while continuing voice communication (VoIP (Voice over IP) communication) using packet communication.

Further, in the above described image information sharing system, the first computer may include a touch panel, and further include first computer display means for displaying an image file indicated by the address information obtained by the obtaining means, on the touch panel, and touch position obtaining means for obtaining, when a predetermined touch operation is carried out on the touch panel, a position on the display image, designated by the touch operation, the first computer transmission means may include position information indicating the position obtained by the touch position obtaining means, in a part of the packet related to the voice communication, and transmit the packet, and the second computer display means may obtain the position information from the packet related to the voice communication, and display a predetermined image at the position on the display image, indicated by the position information.

With the above, the user of the first computer can provide route guidance, while designating a position on the map.

### BRIEF DESCRIPTION OF THE DRAWINGS

FIG. 1 is a diagram showing a hardware configuration of a portable terminal according to an embodiment of the present invention;

FIG. 2 is a diagram showing a system configuration of an image information sharing system according to this embodiment and an internal structure of a portable phone;

FIG. 3 is a functional block diagram of a CPU of a portable terminal according to an embodiment of the present invention;

FIG. 4 is a diagram showing a map image shown in the portable terminal according to an embodiment of the present invention;

FIG. 5 is a diagram showing a packet according to an embodiment of the present invention, which includes a digital signal, address information, and touch position information; and

FIG. 6 is a flowchart of a process carried out in a portable terminal according to an embodiment of the present invention.

### BEST MODE FOR CARRYING OUT THE INVENTION

An embodiment of the present invention will be described with reference to the drawings.

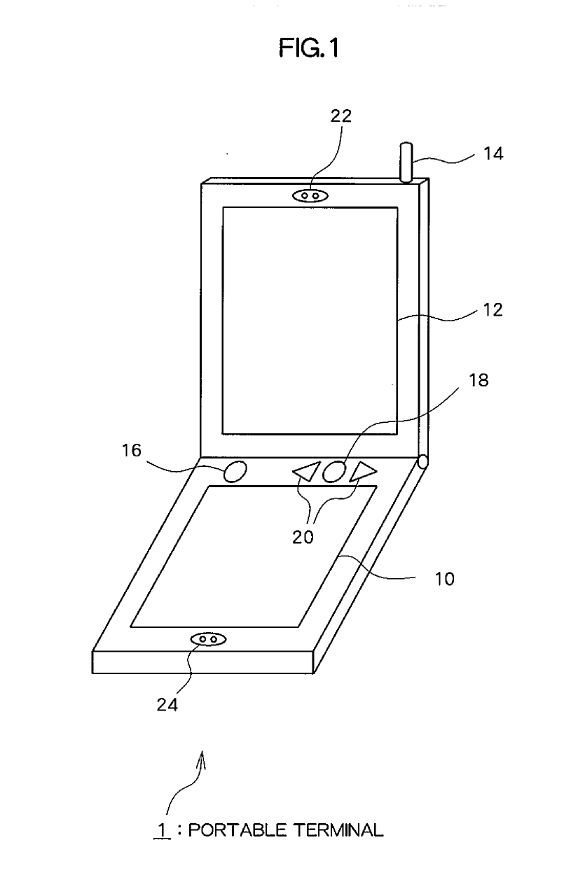

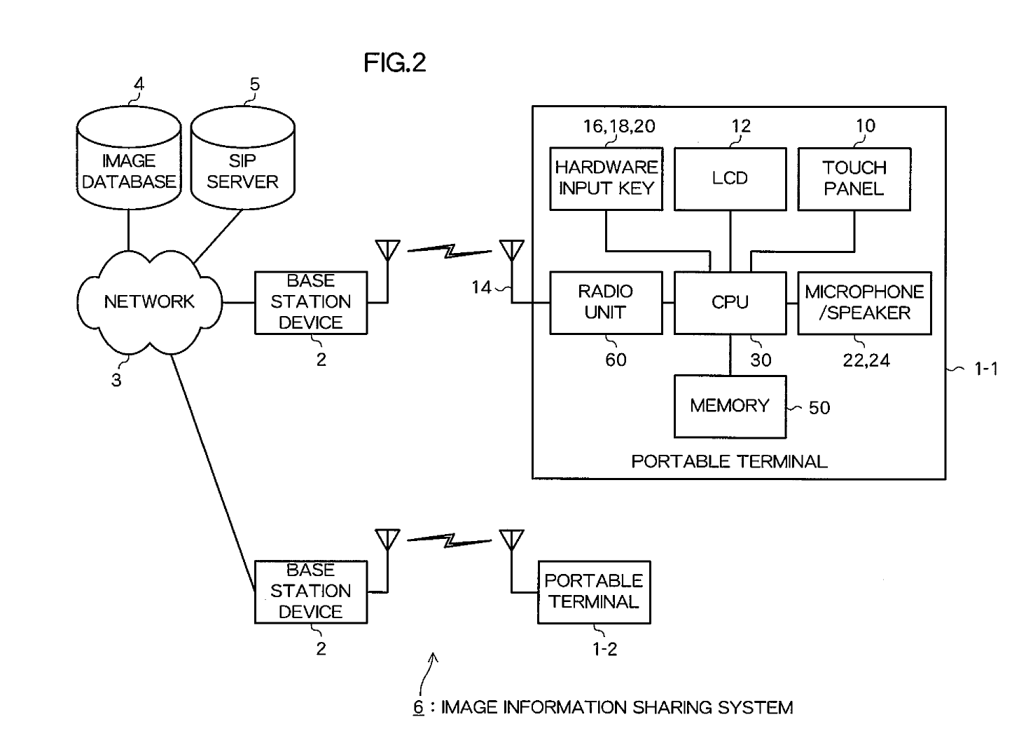

FIG. 1 is a diagram showing a hardware configuration of a portable terminal 1 according to this embodiment. FIG. 2 is a diagram showing a system configuration of an image information sharing system 6 according to this embodiment and an internal structure of the portable terminal 1. As shown in FIGS. 1 and 2, the portable terminal 1 is a computer used as a folding-type portable phone, and includes a touch panel 10, an LCD (liquid crystal monitor: Liquid Crystal Display) 12, an antenna 14, a power button 16, a decision button 18, a scroll button set 20, a speaker 22, a microphone 24, a CPU 30, a memory 50, and a radio unit 60. As shown in FIG. 2, the image information sharing system 6 includes a plurality of portable terminals 1, a plurality of base station devices 2, a network 3, an image database 4, and an SIP server 5.

The portable terminal 1 will be initially described. The CPU 30 is a processing unit for executing a program stored in the memory 50, carrying out a process to control the respective units of the respective devices and implementing the respective functions to be described later. The memory 50 stores programs and data for carrying out this embodiment, and also operates as a working memory of the CPU 30.

The touch panel 10 has a screen, shows an image input from the CPU 30 on the screen, and outputs the coordinates of the touched point on the screen to the CPU 30 when a user touches the screen with a stylus or the like.

The LCD 12 shows an image input from the CPU 30.

The antenna 14 and radio unit 60 carry out radio communication with a base station device 2 according to instructions from the CPU 30. With an IP address assigned to the radio unit 60, the portable terminal 1 carries out IP packet communication with other communication devices, such as another portable terminal 1 and image database 4, via the network 3 using the IP address.

The power button 16, decision button 18, and scroll button set 20 are hardware input keys of the portable terminal 1. The power button 16 functions as an on-hook/off-hook button when continuously pressed for shorter than a predetermined period, and as a power-on/off button when continuously pressed for over a predetermined period of time (a so called press and hold operation). The scroll button set 20 includes a set of at least two (desirably four) scroll buttons. In response to the scroll button 20 pressed, the image shown on the LCD 12 or touch panel 10 is scrolled up/down (and left/right). While the image is scrolling, a selectable area in the displayed image is sequentially selected. The decision button 18 is constructed such that pressing thereof constitutes a click operation for the thus selected area.

The speaker 22 is a voice output device. The speaker 22 converts electrical signals input from the CPU 30 into voices and outputs the voices. The microphone 24 is a voice input device. The microphone 24 converts voices received from the user into electrical signals and outputs the signals to the CPU 30.

The image information sharing system 6 will be hereafter described. The portable terminal 1, base station device 2, and a part of the network 3 together constitute a mobile communication system. The other part of the network 3 is the Internet. The portable terminals 1 are capable of mutual communication utilizing the mobile communication system, and accessible to any database on the Internet.

The image database 4 is a database provided on the Internet, storing many map image files. Each of the map image files is specified by an address (URL: Uniform Resource Locator) on the Internet.

The SIP server 5 is a server which stores a telephone number in association with an IP address. In the case where a communication destination in IP packet communication carried out by the portable terminal 1 is specified by a telephone number, the SIP server 5 carries out conversion between the telephone number and the IP address.

The portable terminal 1 has a function for sharing a map image file with another portable terminal 1 so that the same map image is shown in the respective portable terminals 1. The user carries out route guidance utilizing this. In the following, this function of the portable terminal 1 will be described with reference to the functional block of the portable terminal 1.

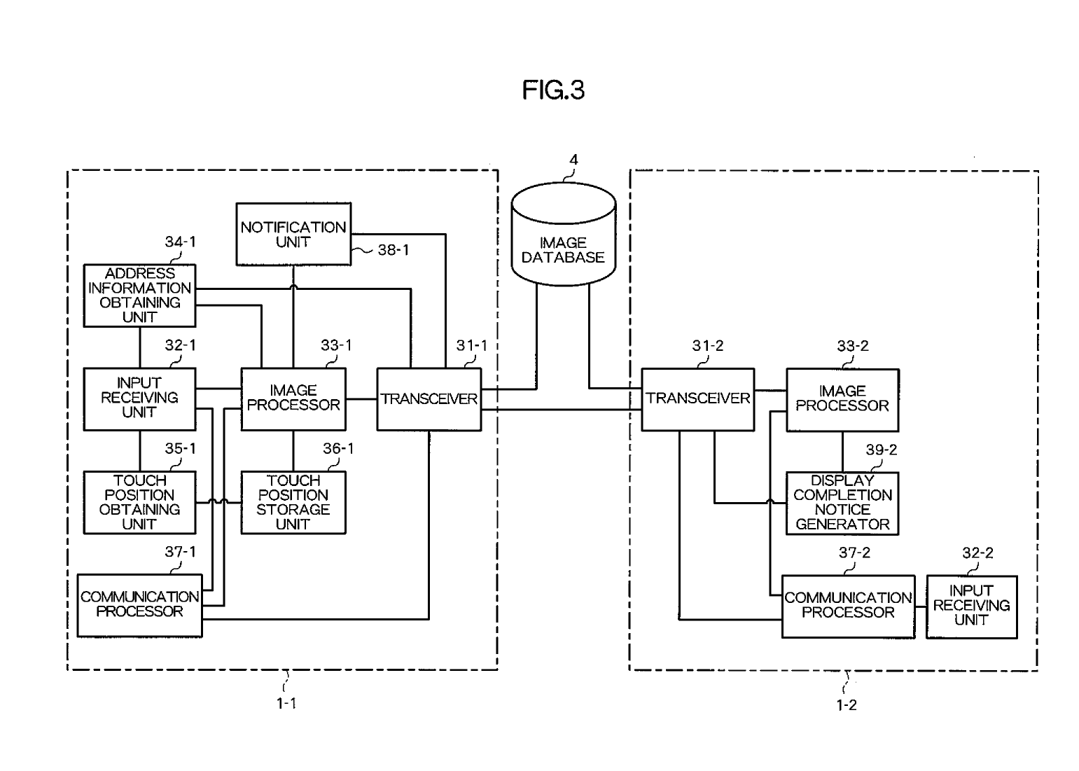

FIG. 3 is a functional block diagram of the CPU 30. Although the functional blocks of the portable terminals 1-1 and 1-2 are shown separate for the purpose of description in this diagram, these functional blocks are generally provided to a single portable terminal 1. An example in which the user of the portable terminal 1-2 asks the user of the portable terminal 1-1 to provide route guidance will be described here. It should be noted that in the following, “-1” attached to a reference number refers to a component included in the portable terminal 1-1, and “-2” attached to a reference number refers to a component included in the portable terminal 1-2.

As shown in FIG. 3, the CPU 30-1 includes, in terms of functions, a transceiver 31-1, an input receiving unit 32-1, an image processor 33-1, an address information obtaining unit 34-1, a touch position obtaining unit 35-1, a touch position storage unit 36-1, a communication processor 37-1, and a notification unit 38-1. Also, as shown in FIG. 3, the CPU 30-2 includes a transceiver 31-2, an input receiving unit 32-2, an image processor 33-2, a communication processor 37-2, and display completion notice generator 39-2.

The transceiver 31 obtains communication data to be transmitted to the image database 4 or another portable terminal 1, and generates and transmits a packet which contains the communication data and destination IP address. Specifically, the transceiver 31 outputs the generated packet to the radio unit 60. The radio unit 60 transmits the input packet to the base station device 2. Further, the transceiver 31 receives a packet sent from the image database 4 or another portable terminal 1 to the IP address of the portable terminal 1. Specifically, the transceiver 31 receives a packet received by the radio unit 60. The transceiver 31 obtains communication data from the packet thus received.

The input receiving unit 32 receives input from the touch panel 10 and hardware input keys.

Between the portable terminals 1-1 and 1-2, voice communication (VoIP communication) on the IP packet communication is carried out. In the following, function concerning the VoIP communication will be described.

The communication processor 37-2 causes the image processor 33-2 to display a keypad image on the touch panel 10-2. The keypad image is an image including numeric keys of at least 0 to 9. The user presses these keys to input the telephone number of the portable terminal 1-1 and further presses the power button 16-2. The input receiving unit 32-2 outputs the telephone number thus input and off-hook information indicating that the power button 16-2 is pressed to the communication processor 37-2.

Upon receipt of the telephone number and off-hook information from the input receiving unit 32-2, the communication processor 37-2 begins communication via IP phone with the communication device (the portable terminal 1-1, here) identified by the input telephone number. Specifically, the communication processor 37-2 outputs a communication start request which contains the input telephone number to the transceiver 31-2. The transceiver 31-2 includes the input communication start request in a packet, and transmits the packet to the SIP server 5. The SIP server 5, having received the packet, obtains the IP address (the IP address of the portable terminal 1-1, here) stored in association with the telephone number, and sends to the portable terminal 1-2. The transceiver 31-2 again transmits a communication start request to the IP address received from the SIP server 5.

Upon receipt of the packet which contains the communication start request sent from the portable terminal 1-2 to the portable terminal 1-1, the transceiver 31-1 extracts the communication start request, and outputs to the communication processor 37-1. Upon input of the communication start request, the communication processor 37-1 causes the image processor 33-1 to show an incoming call image indicating that start of communication is requested, and causes a ringer (not shown) to sound. The user, having noticed the incoming call image displayed or the ringer sounding, presses the power button 16-1 of the portable terminal 1-1, upon which the input receiving unit 32-1 outputs off-hook information indicating that the power button 16-1 is pressed to the communication processor 37-1. With off-hook information input, the communication processor 37-1 outputs a communication start response to the transceiver 31-1, and begins to obtain an electrical signal input from the microphone 24-1.

The transceiver 31-1, having received the communication start response, includes the communication start response in a packet, and transmits to the portable terminal 1-2.

The transceiver 31-2, having received the packet which contains the communication start response sent by the portable terminal 1-1 to the portable terminal 1-2, extracts the communication start response, and outputs to the communication processor 37-2. The communication processor 37-2, having received the communication start request, begins to obtain an electrical signal input from the microphone 24-2.

With packet communication begun as described above, the communication processor 37 of the each of portable terminals 1-1 and 1-2 converts the electrical signal input from the microphone 24 into a digital signal, and outputs to the transceiver 31. The transceiver 31 then includes the digital signal input from the communication processor 37 in a packet, and transmits the packet.

Further, the transceiver 31, having received the packet sent from another portable terminal 1, outputs the digital signal contained in the packet to the communication processor 37. The communication processor 37 converts the digital signal input into an electrical signal, and outputs to the speaker 22. The speaker 22 converts the electrical signal thus input into voice, and outputs.

In the above described manner, VoIP communication is carried out between the portable terminals 1-1 and 1-2.

Next, function concerning map image file sharing between the portable terminals 1-1 and 1-2 will be described.

In response to a user's inputting an image file download instruction, using the touch panel 10-1 or hardware input keys, to instruct to download an image file from the image database 4, the image processor 33-1 downloads the instructed image file from the image database 4, and displays on the touch panel 10-1.

Specifically, the image processor 33-1 outputs communication data which contains an image file download instruction to the transceiver 31-1. The transceiver 31-1 transmits the communication data to the image database 4. The image database 4, having received the image file download instruction, sends the communication data which contains the instructed image file to the portable terminal 1-1. The transceiver 31-1 obtains the communication data, and outputs the image file contained therein to the image processor 33-1. The image processor 33-1 shows a map image described by the image file thus input on the touch panel 10-1.

In a specific example, the user accesses the map image information site, and presses the map image display button provided in the site. Thereupon, a map image file is downloaded from the image database 4 available in the site, and displayed on the touch panel 10-1.

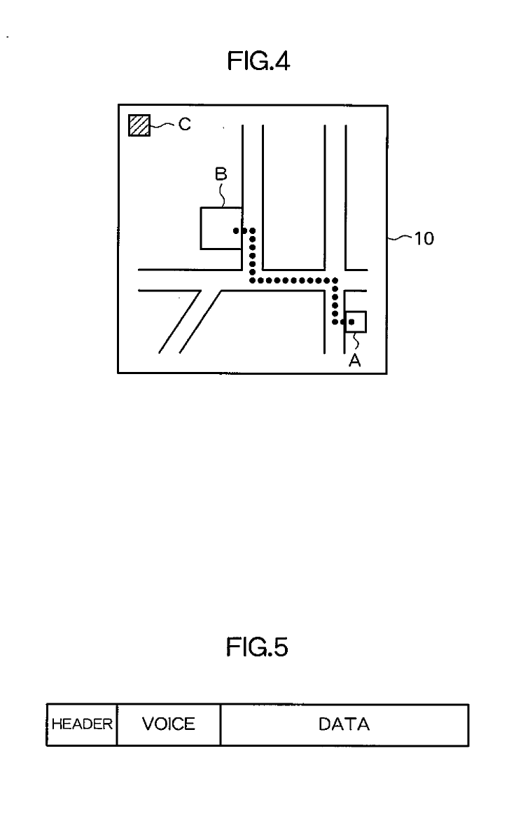

FIG. 4 is a diagram showing an example of a map image shown at this time. As shown in the diagram, a building (buildings A and B are shown in FIG. 4) and a road are shown in the map image.

When the user thereafter inputs an address information transmission instruction which contains information identifying the portable terminal 1 which is the transmission designation, using the touch panel 10-1 or hardware input keys, the address information obtaining unit 34-1 obtains address information (specifically, URL) indicating the address on the network 3, of an image file stored in the image database 4 and shown on the touch panel 10-1 by the image processor 33-1. The address information obtaining unit 34-1 then outputs the address information thus obtained to the transceiver 31-1.

In response to a predetermined touch operation carried out on the touch panel 10-1 where a map image is shown by the image processor 33-1, the touch position obtaining unit 35-1 obtains the position on the displayed image, designated by the touch operation, and outputs to the touch position storage unit 36-1. The touch position storage unit 36-1 stores the input touch position in the memory 50-1. Note that the touch position obtaining unit 35-1 carries out this obtaining process every predetermined period (a sampling period). With the above, when the user keeps touching the touch panel 10-1 (changing the touch position while continuously touching the touch panel 10-1), the touch position obtaining unit 35-1 sequentially obtains a touch position at intervals of the sampling period. As a result, a series of touch positions stored in the memory 50-1 represents the trajectory of the touch position changing. The black circles shown in FIG. 4 represent an example of the trajectory of the touch position changing.

The touch position storage unit 36-1 reads the series of touch positions having been stored in the memory 50-1 every predetermined period, and outputs touch position information indicating these positions to the transceiver 31-1.

The transceiver 31-1 includes the address information input from the address information obtaining unit 34-1 and the touch position information input from the touch position storage unit 36-1 in a part of a packet related to voice communication (a packet containing the digital signal input from the communication processor 37-1), and transmits the packet. FIG. 5 is a diagram showing a specific example of a packet thus transmitted. The transceiver 31-1 includes a header, voice (the digital signal input from the communication processor 37-1), and data (the address information and the touch position information) in a single packet, like a packet shown in the diagram, and transmits the packet.

The transceiver 31-2 receives the packet transmitted by the transceiver 31-1 and obtains the digital signal, address information, and touch position information contained therein. The transceiver 31-2 outputs the digital signal to the communication processor 37-2 and the address information and touch position information to the image processor 33-2, respectively.

Upon receipt of the address information, the image processor 33-2 downloads an image file from the image database 4, based on the received address information. Then, the image processor 33-2 shows a map image contained in the obtained image file on the LCD 12-2 or touch panel 10-2. Specifically, the image processor 33-2 generates an image file download instruction which contains the input address information, and downloads an image file through the same process as the image processor 33-1. With the above, the same map image is shown in the portable terminals 1-1 and 1-2 at the same time.

With the address information input to the image processor 33-2, the display completion notice generator 39-2 waits until displaying of the image file obtained based on the address information is completed. Then, upon completion, the display completion notice generator 39-2 generates a display completion notice indicating that the displaying is completed, and sends the display completion notice via the transceiver 31-2 to the portable terminal 1-1.

Upon receipt of the display completion notice sent as described above, the transceiver 31-1 outputs to the notification unit 38-1. Upon receipt of the display completion notice, the notification unit 38-1 notifies the user of the portable terminal 1-1 that the display completion notice is received. FIG. 4 shows a specific example of the notice. In FIG. 4, a box image C is shown at the upper left on the touch panel 10, which notifies the user that a display completion notice has been input. Note that, obviously, any image other than the box image may be used as an image displayed for the notice. For example, a ringer (not shown) may be sounded, a predetermined sound may be output via the speaker 22, or a vibrator (not shown) may be vibrated, for the notice.

When touch position information is input, the image processor 33-2 shows a predetermined image in a position on the display image, indicated by the touch position information. Specifically, black circles each having a predetermined radius are shown at a series of positions on the display image, indicated by the touch position information input, so as to overlap the map image shown on the LCD 12-2 or touch panel 10-2.

In the above described manner, the map image file is shared between the portable terminals 1-1 and 1-2.

The above described process will be described in detail, while referring to the process flowchart.

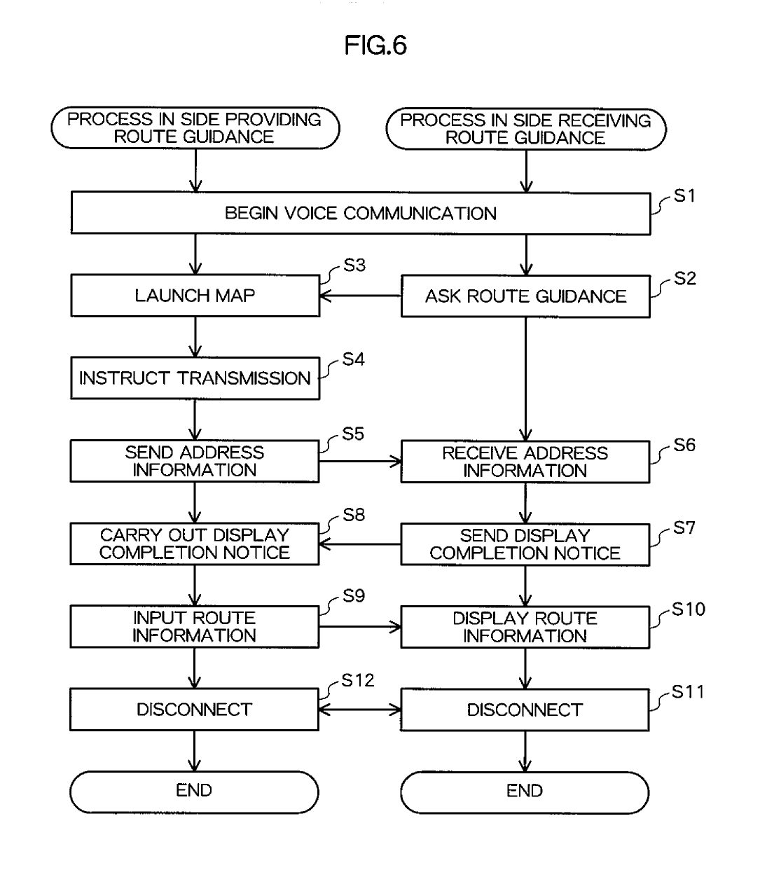

FIG. 6 is a flowchart of a process carried out in the portable terminal 1-1 (a side providing route guidance) and portable terminal 1-2 (a side receiving route guidance).

Initially, voice communication begins between the portable terminals 1-1 and 1-2 (S1). When the user of the portable terminal 1-2, in the conversation related to the voice communication, asks the user of the portable terminal 1-1 to provide route guidance (S2), the user of the portable terminal 1-1 launches a map, while continuing the voice communication (S3). Specifically, the user, using the portable terminal 1-1, accesses the map image information site (image database 4), and shows a map image on the touch panel 10-1. Then, the user inputs an address information transmission instruction (S4), upon which the portable terminal 1-1 sends the address information of the map image shown (S5).

Upon receipt of the address information, the portable terminal 1-2 accesses the map image information site (image database 4) to download the image file, and displays on the touch panel 10-2 or LCD 12-2 (S6). Upon completion of the displaying, the portable terminal 1-2 sends a display completion notice to the portable terminal 1-1 (S7).

Upon receipt of the display completion notice, the portable terminal 1-1 carries out a display completion notice indicating that a display completion notice is received (S8). Also, when the user carries out a touch operation for the map image shown on the touch panel 10-1, touch position information (route information) obtained through the series of touch operations are regularly sent to the portable terminal 1-2. The portable terminal 1-2 receives the route information thus transmitted, and displays the received information so as to overlap the map image displayed (S10).

With the route guidance completed, either the user of the portable terminal 1-1 or the user of the portable terminal 1-2 presses the power button 16 to thereby disconnect the voice communication (S11, S12).

As described above, according to the image information sharing system 6, which utilizes address information of an image file, a map image can be shared without sending an image file itself, even though a file name and an image file are not shared beforehand between the portable terminals 1-1 and 1-2.

Also, as the user of the portable terminal 1-1 can know, by reference to the notice, that an image file is shown on the portable terminal 1-2, it is possible to begin, e.g., explanation of a map with the map image shown on the respective terminals.

Further, it is possible to share a map image while continuing VoIP communication. Further, it is possible to provide route guidance while designating a position on the map.

It should be noted that the present invention is not limited to the above described embodiment. For example, although an example of providing route guidance using a map image is described in the above embodiment, sharing any image, not limited to a map image, is possible according to the present invention. In a specific example, sharing a diagram showing the inside of a building may enable route guidance when moving in the building.

1. An image information sharing system comprising a first computer and a second computer, wherein
the first computer and the second computer are both provided on a network, capable of accessing an image database storing a plurality of image files,
the first computer comprises
obtaining means for obtaining address information indicating an address on the network, of an image file stored in the image database, and
first computer transmission means for transmitting the address information obtained by the obtaining means to the second computer, and
the second computer comprises
second computer receiving means for receiving the address information from the first computer,
image file obtaining means for obtaining the image file from the image database, based on the address information received by the second computer receiving means, and
second computer display means for displaying the image file obtained by the image file obtaining means.

2. The image information sharing system according to claim 1, wherein the second computer further comprises
second computer transmission means for transmitting to the first computer, a display completion notice indicating that displaying by the second computer display means is completed, and
the first computer further comprises
first computer receiving means for receiving the display completion notice from the second computer, and
notification means for notifying a user of this computer, when the display completion notice is received by the first computer receiving means, that the display completion notice is received.

3. The image information sharing system according to claim 1 or 2, wherein
the first computer and the second computer carry out voice communication using packet communication with each other, and
the first computer transmission means includes the address information in a part of a packet related to the voice communication, and transmits the packet.

4. The image information sharing system according to claim 3, wherein
the first computer comprises a touch panel, and
further comprises
first computer display means for displaying an image file indicated by the address information obtained by the obtaining means, on the touch panel, and
touch position obtaining means for obtaining, when a predetermined touch operation is carried out on the touch panel, a position on the display image, designated by the touch operation,
the first computer transmission means includes position information indicating the position obtained by the touch position obtaining means, in a part of the packet related to the voice communication, and transmits the packet and
the second computer display means obtains the position information from the packet related to the voice communication, and displays a predetermined image at the position on the display image, indicated by the position information.
